(19) United States
(12) Patent Application Publication
(10) Pub. No.: US 2025/0085504 A1
(43) Pub. Date: Mar. 13, 2025

(54) LENS BARREL

(71) Applicant: FUJIFILM Corporation, Tokyo (JP)

(72) Inventors: Masahiro HIDESHIMA, Saitama (JP); Mitsuhiko OKA, Saitama (JP)

(73) Assignee: FUJIFILM Corporation, Tokyo (JP)

(21) Appl. No.: 18/815,828

(22) Filed: Aug. 26, 2024

(30) Foreign Application Priority Data
Sep. 11, 2023 (JP) 2023-146896

(51) Int. Cl. G02B 7/02

(52) U.S. Cl. CPC G02B 7/023; G02B 7/021

(57) ABSTRACT

The lens barrel includes a first frame, a second frame that holds a lens positioned closest to an object side, that is accommodated in the first frame, and of which a position and/or a degree of inclination is adjustable with respect to the first frame, and a third frame that is attached to the first frame and that is disposed between an inner periphery of the first frame and an outer periphery of the second frame as seen from the object side. In the lens barrel, a first portion of the second frame that is positioned closest to the object side in an optical axis direction is disposed between a second portion of the third frame that is positioned closest to the object side and a third portion of the third frame that is positioned closest to an image side.

### CROSS-REFERENCE TO RELATED APPLICATION

The present application claims priority under 35 U.S.C ξ 119(a) to Japanese Patent Application No. 2023-146896 filed on Sep. 11, 2023, which is hereby expressly incorporated by reference, in its entirety, into the present application.

### BACKGROUND OF THE INVENTION

### 1. Field of the Invention

The present invention relates to a lens barrel.

### 2. Description of the Related Art

A technique is known in which a decorative ring is disposed, in a lens barrel in which optical axis adjustment is performed by means of a lens (a first lens group) positioned closest to an object side, on a front side (the object side) with respect to a lens frame that holds the first lens group to cover and hide an optical axis adjustment mechanism or the like and to improve the external appearance quality (for example, JP2016-109750A and JP2017-116788A).

### SUMMARY OF THE INVENTION

One embodiment according to the present disclosed technology provides a lens barrel with which it is possible to achieve improvement in external appearance quality.

(1) A lens barrel including: a first frame; a second frame that holds a lens positioned closest to an object side, that is accommodated in the first frame, and of which a position and/or a degree of inclination is adjustable with respect to the first frame; and a third frame that is attached to the first frame and that is disposed between an inner periphery of the first frame and an outer periphery of the second frame as seen from the object side, in which a first portion of the second frame that is positioned closest to the object side in an optical axis direction is disposed between a second portion of the third frame that is positioned closest to the object side and a third portion of the third frame that is positioned closest to an image side.

(2) The lens barrel described in (1), in which the first portion is positioned at a position closer to the image side than the second portion is by a distance equal to or greater than a distance δ.

(3) The lens barrel described in (2), in which a value that exceeds a maximum amount of displacement of the first portion in the optical axis direction that is caused due to the adjustment is set as the distance δ.

(4) The lens barrel described in (1), in which the first portion is positioned at a position closer to the image side than the second portion is by a distance equal to or greater than a distance ξ in a case where the position and/or the degree of inclination of the second frame is adjusted by a maximum adjustment amount.

(5) The lens barrel described in (4), in which the distance ξ is 0.3 mm.

(6) The lens barrel described in any one of (1) to (5), in which the third frame includes an annular recess portion provided at an inner peripheral portion as seen from the object side, and the first portion is positioned closer to the object side than a fourth portion of the recess portion that is positioned closest to the image side.

(7) The lens barrel described in any one of (1) to (6), in which the third frame includes an annular projection portion provided at an inner peripheral portion of an end surface on the object side.

(8) The lens barrel described in (7), in which the projection portion of the third frame has a tapered shape of which a diameter decreases toward the object side.

(9) The lens barrel described in (7) or (8), in which an end portion of the second frame that is on the object side has a tapered shape of which a diameter decreases toward the image side.

(10) The lens barrel described in (7), in which the projection portion of the third frame has a stepped shape of which a diameter decreases toward the object side in a stepwise manner.

(11) The lens barrel described in (9) or (10), in which the end portion of the second frame that is on the object side has a stepped shape of which a diameter decreases toward the image side in a stepwise manner.

(12) The lens barrel described in any one of (1) to (11), in which the second frame includes the first portion provided at a portion adjacent to an inner periphery of the third frame as seen from the object side.

(13) The lens barrel described in any one of (1) to (12), in which the first portion and the second portion are disposed to be adjacent to each other as seen from the object side.

(14) The lens barrel described in any one of (1) to (13), in which the first portion and the second portion have the same hue.

(15) The lens barrel described in (14), in which Munsell chroma values of the first portion and the second portion are equal to or smaller than a threshold value.

(16) The lens barrel described in (14) or (15), in which a hue difference related to a hue ring in Munsell color system between the first portion and the second portion is equal to or smaller than a threshold value.

(17) The lens barrel described in any one of (14) to (16), in which lightness of the first portion and the second portion of the second frame and the third frame is relatively high.

(18) The lens barrel described in any one of (14) to (17), in which lightness of the first portion and the second portion is relatively higher than lightness of an outer peripheral surface of the second frame and lightness of an inner peripheral surface of the third frame.

(19) The lens barrel according to any one of (1) to (18), wherein the third frame is a nameplate.

### BRIEF DESCRIPTION OF THE DRAWINGS

FIG. 1 is a front view showing an external configuration of an interchangeable lens.

FIG. 2 is a side view showing an external configuration of the interchangeable lens.

FIG. 3 is a cross-sectional view showing a schematic internal configuration of the interchangeable lens.

FIG. 4 is a view showing a schematic configuration of a tilt adjustment mechanism.

FIG. 5 is an enlarged view of one of attachment portions.

FIG. 6 is a cross-sectional view taken along line 6-6 of FIG. 5.

FIG. 7 is a cross-sectional perspective view showing an attachment structure for a decorative ring.

FIG. 8 is an enlarged cross-sectional view of the attachment part for the decorative ring.

FIG. 9 is a cross-sectional perspective view showing the configuration of a main part of an interchangeable lens of a second embodiment.

FIG. 10 is an enlarged cross-sectional view of a main part of the interchangeable lens of the second embodiment.

FIG. 11 is a front view showing an example of an interchangeable lens in which a first portion and a second portion are made brighter than the vicinities thereof.

FIG. 12 is an enlarged view of a part of FIG. 11.

### DESCRIPTION OF THE PREFERRED EMBODIMENTS

Hereinafter, preferred embodiments of the present invention will be described in detail with reference to the attached drawings.

Here, a case where the present invention is applied to an interchangeable lens of a lens-interchangeable camera will be described as an example. The lens-interchangeable camera is a camera in which a lens can be freely exchanged. Particularly, in the present embodiment, a case where the present invention is applied to an interchangeable lens of a mirrorless single-lens camera will be described as an example. A mirrorless single-lens camera is a type of digital camera, and is a generic term for types of lens-interchangeable digital cameras in which an image is checked through an electronic viewfinder (EVF) or a live view monitor (a monitor provided at a rear surface or a side surface of a camera body) instead of an optical viewfinder of a single-lens reflex camera.

### First Embodiment

### Appearance Configuration of Interchangeable Lens

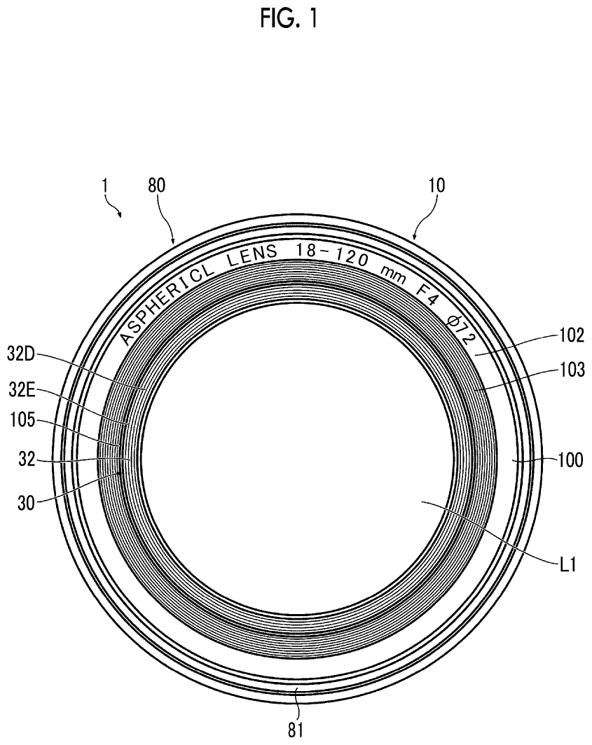

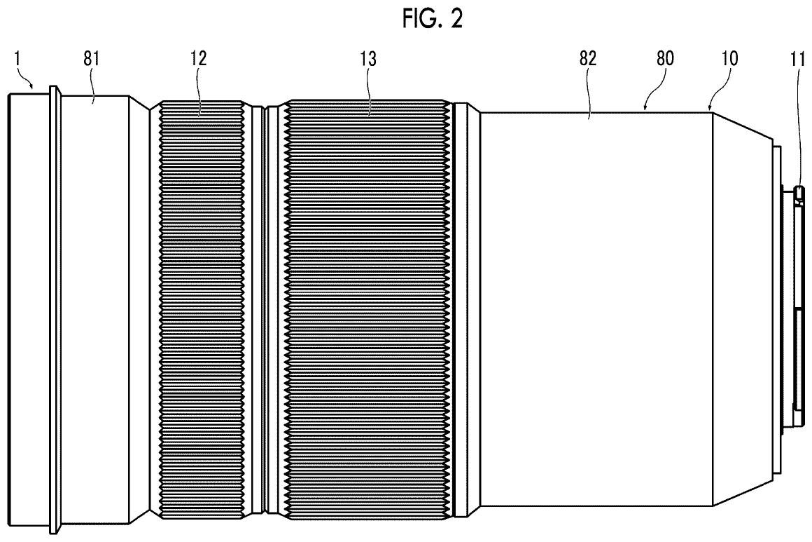

FIG. 1 is a front view showing an external configuration of an interchangeable lens. FIG. 2 is a side view showing the external configuration of the interchangeable lens. Note that in FIG. 2, the left side of the paper surface is an object side, and the right side is an image side. It will be assumed that the object side is a front side of an interchangeable lens 1 and the image side is a rear side of the interchangeable lens.

As described above, the interchangeable lens 1 of the present embodiment is an interchangeable lens for a mirrorless single-lens camera. Particularly, the interchangeable lens 1 shown in FIGS. 1 and 2 is an interchangeable lens (a so-called zoom lens) having a zoom function. In addition, the interchangeable lens 1 shown in FIGS. 1 and 2 is a zoom lens having an electric zooming (also referred to as power zoom) function. The electric zooming function is a function of electrically zooming in response to a zooming operation performed by a user. In addition, the interchangeable lens 1 shown in FIGS. 1 and 2 is a lens having a fixed total length. The lens having a fixed total length means a lens of which the total length does not change in the case of a zooming operation and a focusing operation.

As shown in FIGS. 1 and 2, the interchangeable lens 1 includes a cylindrical lens barrel 10.

As shown in FIG. 2, the interchangeable lens 1 includes a mount 11 provided at a rear end portion (an end portion on the image side) of the lens barrel 10. The interchangeable lens 1 is attachably and detachably mounted to a camera body via the mount 11. The standard of the mount is not particularly limited. For example, a bayonet mount is adopted in the present embodiment.

As shown in FIG. 2, the interchangeable lens 1 includes a focus ring 12 and a zoom ring 13 provided on an outer periphery of the lens barrel 10.

The focus ring 12 is an operation member for a focusing operation. The focus ring 12 is operated to be rotated in a circumferential direction of the lens barrel 10. In the present embodiment, the focus ring 12 can be rotated forward and backward. In the interchangeable lens 1, the direction of focusing is controlled in accordance with the direction of rotation of the focus ring 12. In addition, in the present embodiment, the focus ring 12 can be rotated without restriction. In addition, in the interchangeable lens 1, the amount of movement of a focus (the amount of movement of a focal position) is controlled in accordance with the angle of rotation (the amount of rotation) of the focus ring 12.

The zoom ring 13 is an operation member for a zooming operation. The zoom ring 13 is operated to be rotated in the circumferential direction of the lens barrel 10. In the present embodiment, the zoom ring 13 can be rotated forward and backward. In the interchangeable lens 1, a zoom direction (zoom-in or zoom-out) is controlled in accordance with the direction of rotation of the zoom ring 13. In addition, in the present embodiment, the zoom ring 13 can be rotated without restriction. In the interchangeable lens 1, a zoom amount (the amount of a change in focal length) is controlled in accordance with the angle of rotation of the zoom ring 13.

### Internal Structure of Interchangeable Lens

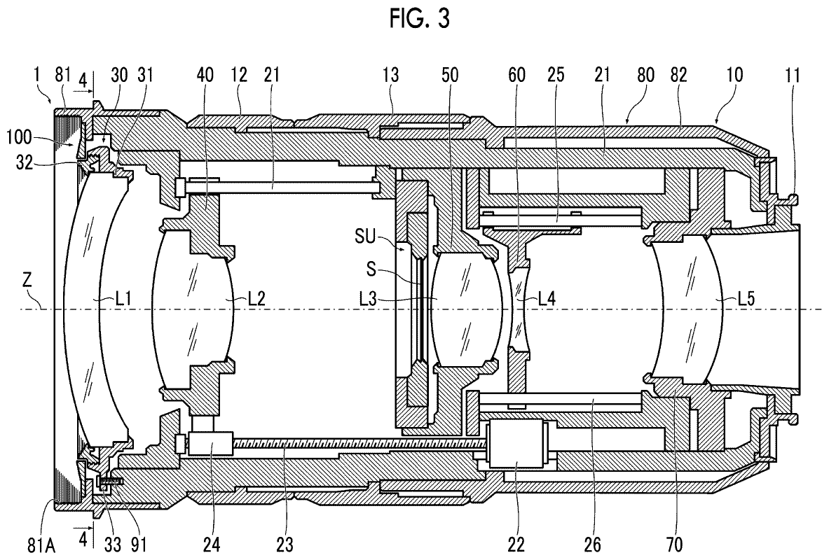

FIG. 3 is a cross-sectional view showing a schematic internal configuration of the interchangeable lens. Note that in FIG. 3, the left side of the paper surface is the object side, and the right side is the image side.

### Configuration of Optical System

As shown in FIG. 3, the interchangeable lens 1 of the present embodiment includes a first lens group L1, a second lens group L2, a third lens group L3, a fourth lens group L4, and a fifth lens group L5 in order from the object side toward the image side. In addition, the interchangeable lens 1 of the present embodiment includes a stop S between the second lens group L2 and the third lens group L3.

In the interchangeable lens 1 of the present embodiment, the first lens group L1, the third lens group L3 and the fifth lens group L5 are fixed lens groups. On the other hand, the second lens group L2 and the fourth lens group L4 are moving lens groups. Each of the lens groups is composed of at least one lens.

The focal position of the interchangeable lens 1 is changed in a case where the fourth lens group L4 is moved along an optical axis Z. That is, focus adjustment is performed.

The focal length of the interchangeable lens 1 is changed in a case where the second lens group L2 is moved along the optical axis Z. That is, zooming is performed. Note that the fourth lens group L4 is also moved during the zooming. The fourth lens group L4 is moved together with the second lens group L2 to compensate for a change in focal position accompanied by the zooming. That is, the fourth lens group L4 also functions as a compensator.

The stop S is composed of, for example, an iris stop. A unit (stop unit) SU including a drive mechanism of the stop S is disposed between the second lens group L2 and the third lens group L3.

The interchangeable lens 1 of the present embodiment has a function for tilt adjustment as a function for optical adjustment. The tilt adjustment is performed at the first lens group L1. Specifically, the tilt adjustment is performed by tilting an optical axis of the first lens group L1 with respect to the optical axis Z of the lens barrel 10.

### Lens Barrel

The lens barrel 10 includes a lens barrel body 20 and an exterior body 80.

The lens barrel body 20 is a so-called fixed cylinder and is a constituent element that is fixed to a camera body in a case where the interchangeable lens 1 is mounted to the camera body. The mount 11 is provided at a rear end portion of the lens barrel body 20.

The lens barrel body 20 accommodates an optical system.

The first lens group L1 is a lens positioned closest to the object side in an optical axis direction. The first lens group L1 is held at a first lens frame 30 and is accommodated in the lens barrel body 20. As described above, the first lens group L1 is a fixed lens group. Accordingly, the first lens frame 30 is fixed to the lens barrel body 20 and is disposed at a predetermined position in the lens barrel body 20.

As described above, in the interchangeable lens 1 of the present embodiment, the tilt adjustment is performed at the first lens group L1. The tilt adjustment is performed by tilting the first lens frame 30 with respect to the optical axis Z of the lens barrel 10. A mechanism for the tilt adjustment will be described later. In the interchangeable lens 1 of the present embodiment, the first lens frame 30 is an example of a second frame.

The second lens group L2 is held at a second lens frame 40 and is accommodated in the lens barrel body 20. As described above, the second lens group L2 is a moving lens group. Accordingly, the second lens frame 40 is provided to be movable. In the lens barrel body 20, a guide shaft 21 that guides the movement of the second lens frame 40 is provided. The guide shaft 21 is disposed along the optical axis Z.

The second lens group L2 is driven by a zoom motor 22. The zoom motor 22 is composed of, for example, a coreless motor. A lead screw 23 is disposed along the optical axis Z inside the lens barrel body 20. The second lens frame 40 is connected to a nut 24 attached to the lead screw 23. The zoom motor 22 rotates the lead screw 23. In a case where the lead screw 23 is rotated by the zoom motor 22, the nut 24 moves along the lead screw 23. Accordingly, the second lens frame 40 moves along the optical axis Z. In addition, the second lens group L2 moves along the optical axis Z.

The third lens group L3 is held at a third lens frame 50 and is accommodated in the lens barrel body 20. As described above, the third lens group L3 is a fixed lens group. Accordingly, the third lens frame 50 is fixed to the lens barrel body 20 and is disposed at a predetermined position in the lens barrel body 20.

The stop unit SU is attached to the third lens frame 50 and is accommodated in the lens barrel body 20. As described above, the stop unit SU is disposed between the second lens group L2 and the third lens group L3.

The fourth lens group L4 is held at a fourth lens frame 60 and is accommodated in the lens barrel body 20. As described above, the fourth lens group L4 is a moving lens group. Accordingly, the fourth lens frame 60 is provided to be movable. In the lens barrel body 20, a main shaft 25 and a sub shaft 26 that guide the movement of the fourth lens frame 60 are provided. Both of the main shaft 25 and the sub shaft 26 are disposed along the optical axis Z.

The fourth lens group L4 is driven by a focus motor (not shown). The focus motor is composed of, for example, a linear motor. The focus motor directly moves the fourth lens frame 60 along the main shaft 25 and the sub shaft 26. Accordingly, the fourth lens group L4 moves along the optical axis Z.

The fifth lens group L5 is held at a fifth lens frame 70 and is accommodated in the lens barrel body 20. As described above, the fifth lens group L5 is a fixed lens group. Accordingly, the fifth lens frame 70 is fixed to the lens barrel body 20 and is disposed at a predetermined position in the lens barrel body 20.

The exterior body 80 is mainly composed of a front cover 81 and a rear cover 82. The front cover 81 is mounted onto an outer periphery of a front end of the lens barrel body 20. Light shielding grooves 81A are provided at an inner peripheral surface of the front cover 81. The rear cover 82 is mounted onto a rear end outer peripheral portion of the lens barrel body 20. Each of the front cover 81 and the rear cover 82 mounted onto the lens barrel body 20 is fixed to the lens barrel body 20 by means of a screw (not shown) and is integrated with the lens barrel body 20. In the interchangeable lens 1 of the present embodiment, a component obtained through integration of the lens barrel body 20 and the exterior body 80 is an example of a first frame.

As shown in FIGS. 1 and 3, a ring-shaped decorative ring 100 is attached to an inner peripheral portion of the front cover 81. The decorative ring 100 is disposed to be orthogonal to the optical axis Z (may also be disposed in a state of being approximately orthogonal to the optical axis Z), and is disposed between an inner periphery of the front cover 81 and an outer periphery of the first lens frame 30 in a view of the lens barrel 10 as seen from the object side. The decorative ring 100 functions as a nameplate and the details and the specifications (so-called specs) or the like of the interchangeable lens 1 are written on a surface (an end surface on the object side) thereof. For example, information about a focal length, a maximum aperture, a filter diameter, glass used, a lens used, a coating used, a manufacturer name, and the like is written. For example, FIG. 1 shows an example in which information about a lens used (ASPHERICAL LENS), information about a focal length (18-120 mm), information about a maximum aperture (F4), and information about a filter diameter (φ72) are written. An attachment structure for the decorative ring 100 will be described later. In the present embodiment, the decorative ring 100 is an example of a third frame.

### Tilt Adjustment Mechanism

As described above, in the interchangeable lens 1 of the present embodiment, the tilt adjustment is performed by tilting the first lens frame 30 with respect to the optical axis Z of the lens barrel 10.

As shown in FIG. 3, the first lens frame 30 includes a first lens frame body 31 and a fixation ring 32.

The first lens frame body 31 has a cylindrical shape and the first lens group L1 is held at an inner peripheral portion thereof.

The fixation ring 32 is a member provided to fix the first lens group L1 to the first lens frame body 31. The fixation ring 32 includes a fixation ring body 32A and a flange portion 32B. The fixation ring body 32A has an annular shape. The flange portion 32B is a brim-shaped portion that projects from an outer periphery of a rear end portion of the fixation ring body 32A. The flange portion 32B includes a male screw portion 32C provided at an outer periphery thereof. The fixation ring 32 is mounted to the first lens frame body 31 with the male screw portion 32C engaged with a female screw portion 31A, the female screw portion 31A being provided at an inner periphery of the first lens frame body 31. The fixation ring 32 mounted to the first lens frame body 31 is engaged with the first lens group L1 held at the first lens frame body 31 to fix the first lens group L1 to the first lens frame body 31.

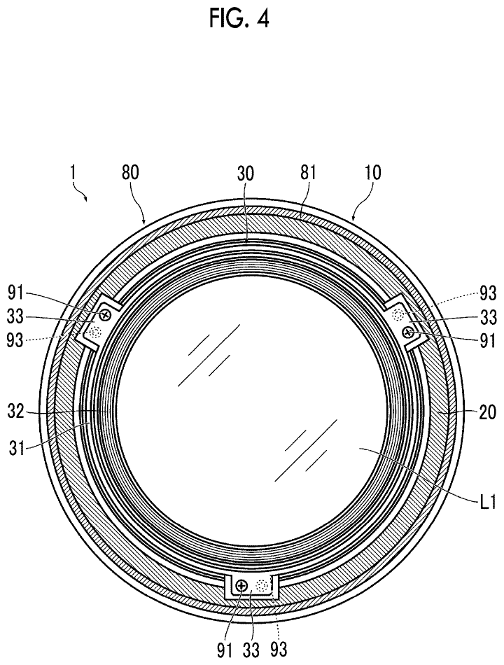

FIG. 4 is a view showing a schematic configuration of a tilt adjustment mechanism. FIG. 4 corresponds to a cross-sectional view taken along line 4-4 of FIG. 3.

As shown in FIG. 4, the first lens frame 30 is provided with attachment portions 33 for attachment of the first lens frame 30 to the lens barrel body 20. The attachment portions 33 are provided at three positions on an outer periphery of the first lens frame body 31. The attachment portions 33 have the same configuration as each other. The attachment portions 33 are disposed at equal intervals (at intervals of) 120° along a circumferential direction.

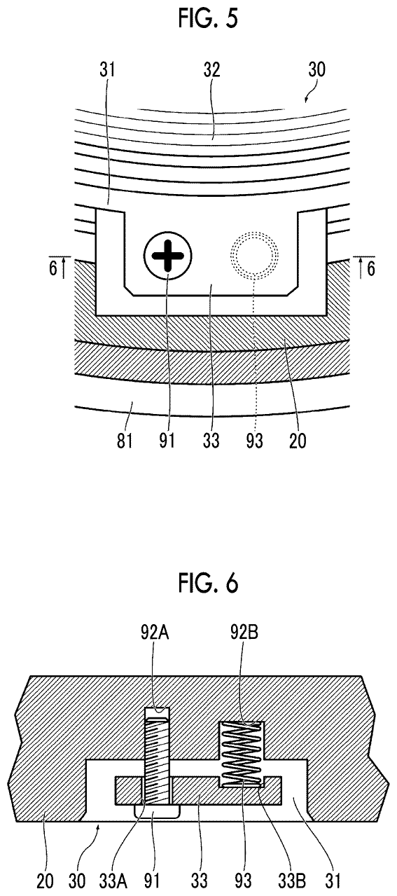

FIG. 5 is an enlarged view of one of the attachment portions. FIG. 6 is a cross-sectional view taken along line 6-6 of FIG. 5.

Each attachment portion 33 is composed of a rectangular plate-shaped piece orthogonal to an optical axis and is disposed to protrude radially outward. The attachment portion 33 is provided with a screw attachment hole 33A provided to screw the first lens frame 30 to the lens barrel body 20. The screw attachment hole 33A is composed of a through-hole. In addition, the attachment portion 33 is provided with a spring engagement portion 33B. The spring engagement portion 33B is composed of a recess portion and is provided at a rear surface (a rear end surface) of the attachment portion 33.

Regarding the first lens frame 30, an adjustment screw 91 is inserted into the screw attachment hole 33A of each attachment portion 33 so that the first lens frame 30 is screwed to the lens barrel body 20 and the first lens frame 30 is mounted to the lens barrel body 20.

At a front end of the lens barrel body 20, support portions 92 are provided at three positions corresponding to the three attachment portions 33 of the first lens frame 30. The support portions 92 are composed of recess portions that can accommodate the attachment portions 33 and are disposed at equal intervals (at intervals of) 120° along the circumferential direction.

Each support portion 92 is provided with a screw hole 92A and a spring 93. The screw hole 92A is disposed along the optical axis Z. The spring 93 is composed of a coil spring and is disposed along the optical axis Z. The spring 93 is provided at the support portion 92 with the spring 93 held at a spring holding portion 92B provided at the support portion 92. The spring holding portion 92B is composed of a recess portion that can accommodate the spring 93. The spring 93 is disposed at the support portion 92 with a proximal end portion thereof accommodated in the spring holding portion 92B.

Regarding the first lens frame 30, the attachment portions 33 are positionally aligned with the respective support portions 92 and the attachment portions 33 are screwed to the respective support portions 92 by means of the adjustment screws 91 so that the first lens frame 30 is mounted to the lens barrel body 20. The screwing of the attachment portions 33 is performed by inserting the adjustment screws 91 through the respective screw attachment hole 33A of the attachment portions 33 and fastening the adjustment screws 91 to the screw holes 92A of the support portions 92.

Regarding the first lens frame 30 that is mounted to the lens barrel body 20, the springs 93 of the support portions 92 are engaged with the spring engagement portions 33B provided at the respective attachment portions 33. As a result, the first lens frame 30 is individually biased forward at each attachment portion 33.

In a case where an operation of individually tightening or loosening the adjustment screws 91 with respect to the first lens frame 30 of which each attachment portion 33 is individually biased by the spring 93, the position of each attachment portion 33 is moved forward and backward. As a result, the degree of inclination of the first lens frame 30 is adjusted. That is, the tilt adjustment is performed.

Generally, the tilt adjustment is performed in the case of assembly of the interchangeable lens 1. After the adjustment, each attachment portion 33 is adhesively fixed to the support portion 92 by means of an adhesive such that a state after the adjustment is maintained.

### Attachment Structure for Decorative Ring

As described above, in the interchangeable lens 1 of the present embodiment, the decorative ring 100 is attached to the inner peripheral portion of the front cover 81. The decorative ring 100 is disposed between the inner periphery of the front cover 81 and the outer periphery of the first lens frame 30 in the view of the lens barrel 10 as seen from the object side. Since the decorative ring 100 is attached, a gap formed between an inner periphery of the lens barrel body 20 and the outer periphery of the first lens frame 30 can be blocked in terms of outer appearance, and thus the external appearance quality of the interchangeable lens 1 can be improved.

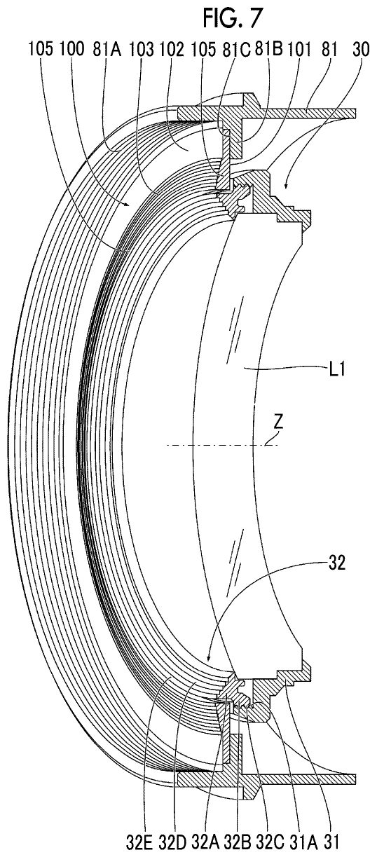

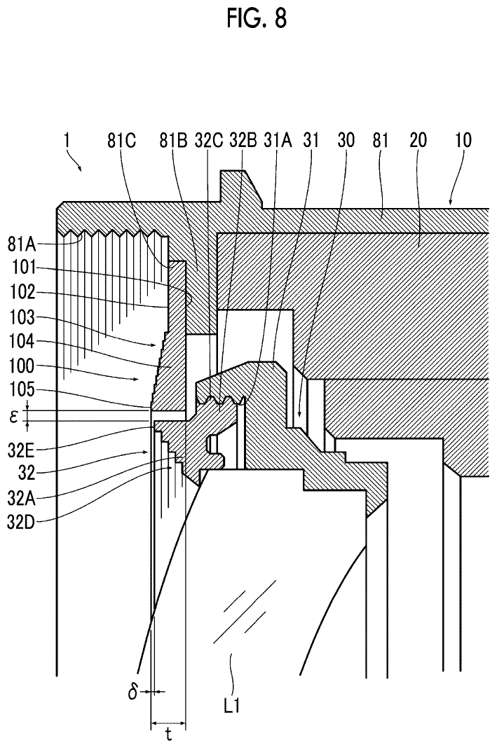

FIG. 7 is a cross-sectional perspective view showing an attachment structure for the decorative ring. FIG. 8 is an enlarged cross-sectional view of the attachment part for the decorative ring.

The decorative ring 100 is configured as a thin plate-shaped member having an annular shape.

An end surface of the decorative ring 100 that is on a rear side (the image side) is configured as a mounting surface 101 with respect to the front cover 81. The mounting surface 101 is composed of a flat surface.

An outer peripheral portion of an end surface of the decorative ring 100 that is on a front side (the object side) is configured as a flat surface 102 and an inner peripheral portion of the end surface is configured as an inclined surface 103 having a stepped shape.

The flat surface 102 is configured as an inscription portion of a nameplate (refer to FIG. 1). That is, items written in a case where the decorative ring 100 is used as a nameplate are inscribed on the flat surface 102.

The inclined surface 103 is composed of an annular projection portion 104 including a stepped inclined surface. The projection portion 104 is provided at an inner peripheral portion of the flat surface 102. In addition, the projection portion 104 has a stepped shape of which the diameter decreases toward the object side in a stepwise manner. In other words, the projection portion 104 has a stepped shape of which the amount of forward protrusion increases from a radially outer side toward a radially inner side in a stepwise manner. Therefore, a portion of the decorative ring 100 that is positioned closest to a front side in the optical axis direction is a front end portion of an innermost peripheral portion of the decorative ring 100. More specifically, a portion of the decorative ring 100 that is positioned closest to a front side in the optical axis direction is an end surface 105 of the innermost peripheral portion that is on the front side. Note that a portion of the decorative ring 100 that is positioned closest to a rear side (the image side) in the optical axis direction is a rear end surface of the decorative ring 100, which is the mounting surface 101.

An inner peripheral portion of the front cover 81 is provided with a decorative ring mounting portion 81B. The decorative ring mounting portion 81B is provided to project from the inner peripheral portion of the front cover 81 as a brim-shaped projection portion having an annular shape. A front end surface of the decorative ring mounting portion 81B is provided with a recess portion 81C into which the decorative ring 100 is fitted. The decorative ring 100 is attached to the decorative ring mounting portion 81B by being fitted into the recess portion 81C and fixed thereto so as not to fall off. The decorative ring 100 is fixed by using, for example, a double-sided tape or an adhesive. Regarding the decorative ring 100 attached to the decorative ring mounting portion 81B, the flat surface 102 of a front outer peripheral portion of the decorative ring 100 is positioned on the same plane as a front end surface of the decorative ring mounting portion 81B. The expression “being positioned on the same plane” may also mean being positioned to be recognized as being on the substantially same plane (so-called the approximately same plane).

The decorative ring 100 attached to the front cover 81 is disposed between the inner periphery of the front cover 81 and the outer periphery of the first lens frame 30 in the view of the lens barrel 10 as seen from the object side. In other words, the first lens frame 30 is disposed inside the decorative ring 100. In the present embodiment, the decorative ring 100 is disposed such that a front end portion (an end portion on the object side) of the first lens frame 30 is accommodated at an inner peripheral portion of the decorative ring 100. The decorative ring 100 is disposed such that a predetermined gap ε is provided between the decorative ring 100 and an outer periphery of the front end portion of the first lens frame 30. The gap ε is set in consideration of the adjustment margin of the tilt adjustment and is made as small as possible. Therefore, at a fitting portion (a portion where the first lens frame 30 is fitted to the inner peripheral portion of the decorative ring 100), the decorative ring 100 and the first lens frame 30 are disposed adjacent to each other in a radial direction.

Here, in the present embodiment, the fixation ring 32 constitutes the front end portion of the first lens frame 30. Therefore, the decorative ring 100 is disposed at an outer periphery of the fixation ring 32. More specifically, the decorative ring 100 is disposed at an outer periphery of the fixation ring body 32A (a portion of the fixation ring 32 that is closer to the front side than the flange portion 32B is).

An end portion of the fixation ring body 32A that is on the front side (the object side) has a stepped shape of which the diameter decreases toward the image side in a stepwise manner. In other words, the end portion has a stepped shape of which the amount of rearward retraction increases from the radially outer side toward the radially inner side in a stepwise manner. As a result, a front end surface of an inner periphery of the fixation ring body 32A is composed of an inclined surface 32D having a stepped shape. In addition, as a result, a front end portion of an outermost peripheral portion of the fixation ring body 32A is a portion of the fixation ring 32 that is positioned closest to the front side in the optical axis direction. More specifically, an end surface 32E on a front side of the outermost peripheral portion of the fixation ring body 32A is a portion of the fixation ring 32 that is positioned closest to the front side in the optical axis direction. This portion is also a portion of the first lens frame 30 that is positioned closest to the front side.

### Relationship Between Decorative Ring and First Lens Frame

The decorative ring 100 is disposed to satisfy the following condition regarding a relationship between the decorative ring 100 and the first lens frame 30. That is, the decorative ring 100 is disposed such that a portion (a first portion) of the first lens frame 30 that is positioned closest to the front side in the optical axis direction is positioned between a portion (a second portion) of the decorative ring 100 that is positioned closest to the front side and a portion (a third portion) of the decorative ring 100 that is positioned closest to the rear side. As described above, the portion (the first portion) of the first lens frame 30 that is positioned closest to the front side in the optical axis direction is the end surface 32E on the front side of the outermost peripheral portion of the fixation ring body 32A. Meanwhile, the portion (the second portion) of the decorative ring 100 that is positioned closest to the front side in the optical axis direction is the end surface 105 on a front side of the innermost peripheral portion of the decorative ring 100. In addition, the portion (the third portion) of the decorative ring 100 that is positioned closest to the rear side in the optical axis direction is the mounting surface 101.

Therefore, the decorative ring 100 is disposed such that the end surface 32E (the first portion) on the front side of the outermost peripheral portion of the fixation ring body 32A is positioned between the end surface 105 (the second portion) on the front side of the innermost peripheral portion and the mounting surface 101 (the third portion). In other words, a portion (the first portion) of the fixation ring 32 that is positioned closest to the front side is positioned behind a portion (the second portion) of the decorative ring 100 that is positioned closest to the front side. That is, the portion (the first portion) of the fixation ring 32 that is positioned closest to the front side does not protrude forward beyond the inner peripheral portion of the decorative ring 100. In addition, the above description means that the portion (the first portion) of the fixation ring 32 that is positioned closest to the front side is disposed within a range of a thickness t of the decorative ring 100 in the optical axis direction.

In a case where the decorative ring 100 and the first lens frame 30 are disposed to satisfy the above-described condition, the following effects are achieved.

The interchangeable lens 1 of the present embodiment has a function for tilt adjustment as a function for optical adjustment. The tilt adjustment is performed by adjusting the degree of inclination of the first lens group L1. The degree of inclination of the first lens group L1 is adjusted by means of the first lens frame 30. That is, the degree of inclination of the first lens group L1 is adjusted by inclining the first lens frame 30 with respect to the lens barrel body 20.

The first lens frame 30 is a lens frame that is positioned closest to the front side in the optical axis direction and can be visually recognized from the outside. Therefore, in a case where the first lens frame 30 in an inclined state is visually recognized, the external appearance quality is impaired. In addition, a product may be erroneously recognized as a defective product.

In the interchangeable lens 1 of the present embodiment, the front end portion (a front end portion of the fixation ring body 32A) of the first lens frame 30 can be visually recognized from the inner peripheral portion of the decorative ring 100.

Since the first lens frame 30 and the decorative ring 100 are adjacent to each other in the radial direction at the fitting portion therebetween, in a case where the front end portion of the first lens frame 30 is inclined in a state of protruding beyond the decorative ring 100, inclination thereof is conspicuous and is easily visually recognized. Particularly, in a case where the portion (the end surface 105) of the decorative ring 100 that is positioned closest to the front side and the portion (the end surface 32E) of the first lens frame 30 that is positioned closet to the front side are adjacent to each other in the radial direction as in the case of the interchangeable lens 1 of the present embodiment and the portion (the end surface 32E) of the first lens frame 30 that is positioned closet to the front side is inclined in a state of protruding beyond the decorative ring 100, inclination thereof is conspicuous and is easily visually recognized.

However, in a case where the front end portion of the first lens frame 30 is closer to an inner side (the image side) than a front end of the decorative ring 100 is as in the case of the interchangeable lens 1 of the present embodiment, inclination of the first lens frame 30 can be made difficult to visually recognize even in the case of inclination of the first lens frame 30. That is, in the case of the interchangeable lens 1 of the present embodiment, since a portion of the first lens frame 30 that is visually recognized is substantially limited to a portion that is visually recognized from a front side and thus inclination of the first lens frame 30 can be made difficult to visually recognize.

As described above, in the case of the interchangeable lens 1 of the present embodiment, inclination of the first lens frame 30 can be made difficult to visually recognize even in a case where the first lens frame 30 is attached after being inclined through the tilt adjustment. Accordingly, the external appearance quality of the interchangeable lens 1 can be improved. Particularly, inclination of the first lens frame 30 can be made difficult to visually recognize and the external appearance quality can be improved regarding a configuration in which the first portion adjacent to the inner periphery of the decorative ring 100 is provided and a configuration in which the first portion and the second portion are disposed to be adjacent to each other in the radial direction as in the interchangeable lens 1 of the present embodiment.

Note that an effect in which inclination of the first lens frame 30 is made difficult to visually recognize is realized in a case where the portion (the first portion) of the first lens frame 30 that is positioned closest to the front side is disposed behind the portion (the second portion) of the decorative ring 100 that is positioned closest to the front side. To maintain a relationship in which the first portion is disposed behind the second portion even in a case where the tilt adjustment is performed, the first portion needs to be positioned at a position behind the second portion while being separated from the second portion by a distance equal to or greater than a distance δ in a state where adjustment has not been performed. The distance δ is set based on the amount of displacement of the first portion in the optical axis direction that is caused due to the tilt adjustment. Specifically, a value that exceeds the maximum amount of displacement of the first portion in the optical axis direction that is caused due to the tilt adjustment is set as the distance δ. The “maximum amount of displacement” here means the amount of displacement of the first portion that occurs in a case where adjustment is performed by the maximum adjustment amount in a state where adjustment has not been performed. Therefore, for example, in a case where the amount of displacement of the first portion that occurs in a case where adjustment is performed by the maximum adjustment amount in a state where adjustment has not been performed is 0.3 mm, a value exceeding 0.3 mm is set as the distance δ. For example, the distance δ is set such that δ=0.5 mm. Accordingly, the first portion is disposed behind the second portion while being separated from the second by a distance equal to or greater than a predetermined distance at all times even in a case where the tilt adjustment is performed. That is, regardless of whether or not the tilt adjustment is performed, a state where the first lens frame 30 does not protrude beyond the decorative ring 100 is maintained.

Note that it is preferable that the distance δ is set such that the first portion is positioned at a position behind the second portion while being separated from the second portion by a distance equal to or greater than a distance ξ in a case where the tilt adjustment is performed on the first lens frame 30 by the maximum adjustment amount. For example, the distance ξ is 0.3 mm. That is, the distance δ is set such that the first portion is positioned at a position behind the second portion while being separated from the second portion by a distance equal to or greater than 0.3 mm in a case where the tilt adjustment is performed on the first lens frame 30 by the maximum adjustment amount. Accordingly, inclination of the first lens frame 30 attributable to the tilt adjustment can be made inconspicuous and the external appearance quality can be improved. Particularly, in a case where end surfaces of the first lens frame 30 and the decorative ring 100 that are adjacent to each other are composed of inclined surfaces each having a stepped shape as in the interchangeable lens 1 of the present embodiment, the inclination of the first lens frame 30 can be made inconspicuous and the external appearance quality can be improved.

Note that in a case where the first lens frame 30 is excessively closer to the rear side than the decorative ring 100 is, vignetting may occur. In addition, the appearance may also be impaired. Particularly, in a case where the first lens frame 30 is made closer to the rear side than the decorative ring 100 is by an amount exceeding the thickness t, a gap is made visually recognizable, which results in a decrease in external appearance quality. Therefore, it is preferable that the portion (the first portion) of the first lens frame 30 that is positioned closest to the front side is positioned ahead of the portion (the third portion) of the decorative ring 100 that is positioned closest to the rear side.

### Second Embodiment

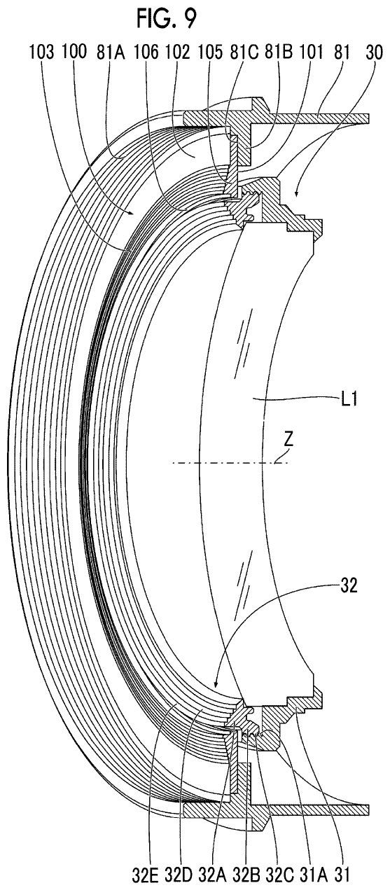

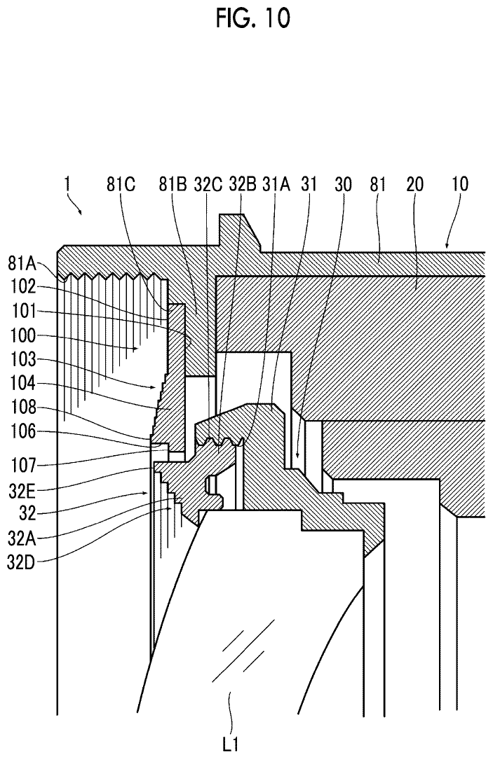

FIG. 9 is a cross-sectional perspective view showing the configuration of a main part of an interchangeable lens of a second embodiment. In addition, FIG. 10 is an enlarged cross-sectional view of a main part of the interchangeable lens of the second embodiment.

In the interchangeable lens 1 of the present embodiment, the configuration of the decorative ring 100 is different from the configuration of the decorative ring 100 of the interchangeable lens 1 of the above-described first embodiment.

As shown in FIGS. 9 and 10, the decorative ring 100 includes an annular recess portion 106 provided at an inner peripheral portion thereof. A bottom surface 107 of the recess portion 106 is composed of a flat surface that is orthogonal (may also be approximately orthogonal) to the optical axis Z. The bottom surface 107 of the recess portion 106 is a portion of the recess portion 106 that is positioned closest to the rear side (the image side).

In the interchangeable lens 1 of the present embodiment, the bottom surface 107 of the recess portion 106 of the decorative ring 100 is a portion adjacent to the first lens frame 30 in the radial direction.

In addition, in the interchangeable lens 1 of the present embodiment, an innermost peripheral portion of the projection portion 104 is a portion of the decorative ring 100 that is positioned closest to the front side (the object side) in the optical axis direction. More specifically, an end surface 108 of the innermost peripheral portion of the projection portion 104 that is on the front side is the portion (the second portion) of the decorative ring 100 that is positioned closest to the front side in the optical axis direction. Regarding the decorative ring 100 of the present embodiment, the end surface 108 of the innermost peripheral portion of the projection portion 104 that is on the front side is a portion adjacent to the recess portion 106.

As in the case of the interchangeable lens 1 of the first embodiment, the decorative ring 100 is disposed to satisfy the following condition regarding a relationship between the decorative ring 100 and the first lens frame 30. That is, the decorative ring 100 is disposed such that the portion (the first portion) of the first lens frame 30 that is positioned closest to the front side is positioned between the portion (the second portion) of the decorative ring 100 that is positioned closest to the front side and the portion (the third portion) of the decorative ring 100 that is positioned closest to the rear side.

Furthermore, in the present embodiment, the decorative ring 100 and the first lens frame 30 are disposed to satisfy the following condition. That is, the decorative ring 100 and the first lens frame 30 are disposed such that the first portion of the first lens frame 30 is positioned closer to the front side (the object side) than a fourth portion of the recess portion 106 that is positioned closest to the rear side (the image side) is as seen from the front side (the object side).

As described above, the portion (the fourth portion) of the recess portion 106 of the decorative ring 100 that is positioned closest to the rear side is the bottom surface of the recess portion 106. Therefore, the first lens frame 30 is disposed such that the portion (the first portion) that is positioned closest to the front side is positioned closer to the front side (the object side) than the bottom surface 107 (the fourth portion) of the recess portion 106 is.

As described above, in the interchangeable lens 1 of the present embodiment, the innermost peripheral portion (a portion adjacent to the outer periphery of the first lens frame 30 in the radial direction) of the decorative ring 100 is disposed closer to the rear side (the image side) than the portion (the first portion) of the first lens frame 30 that is positioned closest to the front side is. Even in the case of the present configuration, similarly to the interchangeable lens 1 of the first embodiment, inclination of the first lens frame 30 can be made difficult to visually recognize and the external appearance quality can be improved.

Note that in a case where the width (the width in the radial direction) of the recess portion 106 is excessively large, inclination is made conspicuous in a case where the tilt adjustment is performed. The appearance design may also be impaired. Therefore, it is preferable to set the width of the recess portion 106 to an appropriate value. For example, the width of the recess portion 106 can be set to a width that is equal or similar to the width of a step portion of the inclined surface 103 having a stepped shape. For example, the width of the recess portion 106 can be set to about 0.4 mm.

In addition, it is preferable to set the depth of the recess portion 106 to an appropriate depth in the same manner. For example, the depth of the recess portion 106 can be set to about 0.8 mm.

### Other Embodiments

### Color

From the viewpoint of making it difficult to visually recognize the inclination of the first lens frame 30 regarding a relationship between the decorative ring 100 and the first lens frame 30, it is preferable that the colors of the decorative ring 100 and the first lens frame 30 are the same as each other.

The expression “colors that are the same as each other” means a combination of colors that are difficult to distinguish from each other for a human. The combination of colors can be empirically obtained or, for example, determined based on a theory such as a color confusion line theory.

For example, colors of which the hues related to the Munsell color system are the same as each other can be regarded as “colors that are the same as each other”. The expression “colors of which the hues are the same as each other” also means colors that can be recognized as colors of which the hues are the substantially same as each other. Colors that can be recognized as colors of which the hues are the substantially same as each other are colors of which a hue difference related to a hue ring in the Munsell color system is equal to or smaller than a threshold value. For example, colors that can be recognized as colors of which the hues are the substantially same as each other are colors of which the hues related to a 20-hue circle in the Munsell color system are the same as each other (a hue difference is equal to or smaller than) 18° or adjacent to each other (a hue difference is equal to or smaller than) 36°.

In addition, for the same reason, it is preferable that the Munsell chroma values of the colors of the decorative ring 100 and the first lens frame 30 are equal to or smaller than a threshold value. That is, it is preferable that the chroma of the decorative ring 100 and the first lens frame 30 is low. Therefore, it is preferable that the colors of the decorative ring 100 and the first lens frame 30 are achromatic.

Furthermore, it is preferable that the Munsell lightness values of the decorative ring 100 and the first lens frame 30 are equal to or smaller than a threshold value. That is, it is preferable that the lightness of the decorative ring 100 and the first lens frame 30 is low. Therefore, it is preferable that the colors of the decorative ring 100 and the first lens frame 30 are black.

Accordingly, it is preferable that the decorative ring 100 and the first lens frame 30 are configured to have the same color as each other and the colors of the decorative ring 100 and the first lens frame 30 are black.

### Brightness of First Portion and Second Portion

As described above, it is preferable that the decorative ring 100 and the first lens frame 30 are configured to have the same color as each other and particularly it is preferable that the colors of the decorative ring 100 and the first lens frame 30 are black. However, it is possible to make inclination of the first lens frame 30 inconspicuous by means of a partial change in brightness (lightness). Specifically, the first portion and the second portion are made relatively brighter than other portions.

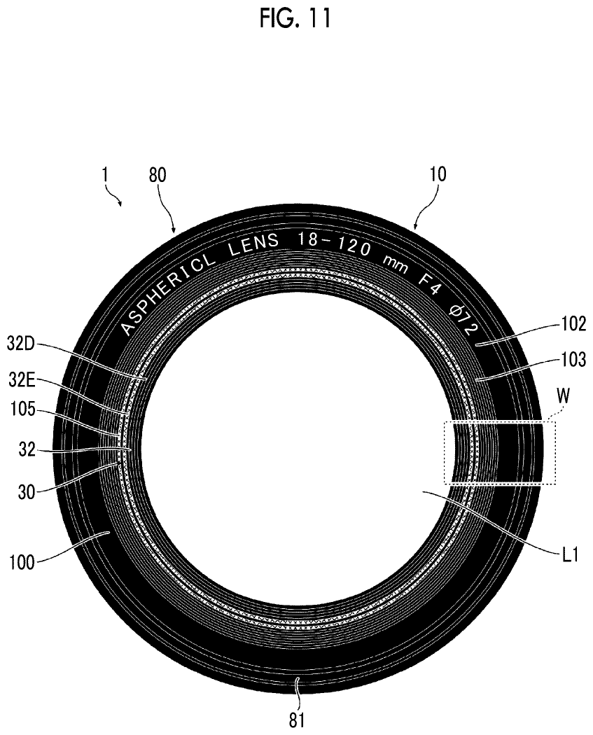

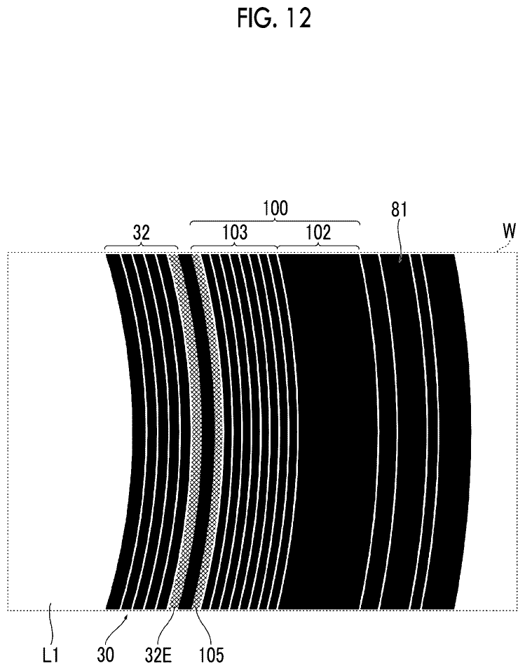

FIG. 11 is a front view showing an example of the interchangeable lens in which the first portion and the second portion are made brighter than the vicinities thereof. In addition, FIG. 12 is an enlarged view (an enlarged view of a rectangular region W in FIG. 11) of a part of FIG. 11.

As shown in FIGS. 11 and 12, the lightness of the front end portion of the outermost peripheral portion of the fixation ring body 32A, which is the first portion, and the lightness of the front end portion of the innermost peripheral portion of the decorative ring 100, which is the second portion, are made relatively higher than the lightness of the other portions. More specifically, as shown in cross-hatched regions in FIGS. 11 and 12, the lightness of the end surface 32E (the first portion) on the front side of the outermost peripheral portion of the fixation ring body 32A and the lightness of the end surface 105 (the second portion) on the front side of the innermost peripheral portion of the decorative ring 100 are made relatively higher than the lightness of the other portions. For example, the lightness of the end surface 32E and the lightness of the end surface 105 are made relatively higher than the lightness of the other portions by three or more stages in terms of lightness related to the Munsell color system.

As a method of making lightness high, for example, a method of painting a corresponding region with paint (bright paint) of which the lightness is relatively higher than the lightness of other regions. For example, in a case where the interchangeable lens is to be painted black, the first portion and the second portion are painted by using black paint with higher lightness. In addition, for example, in a case where the ground color is used (in a case where the colors of the materials of the decorative ring 100 and the first lens frame 30 are black), a method of painting the first portion and the second portion by means of paint with lightness higher than the lightness of the ground color so that the lightness of the first portion and the second portion is made relatively higher can also be adopted.

In addition, a method of making the surface roughness of a corresponding region relatively lower than the surface roughness of other regions so that the lightness of the corresponding region is made relatively higher can also be adopted. That is, a method of increasing the reflectivities of the first portion and the second portion with respect to the entire interchangeable lens so that the lightness of the first portion and the second portion is made relatively higher can also be adopted.

Note that an effect in which inclination of the first lens frame 30 is made inconspicuous is mainly achieved by a difference in lightness between the first and second portions and a gap between the first portion and the second portion. Therefore, the effect is achieved as long as at least the lightness of the first portion and the second portion is higher than the lightness of surfaces constituting the gap. Accordingly, for example, regarding the first lens frame 30, the effect is achieved as long as at least the lightness of the end surface 32E (the first portion) on the front side of the outermost peripheral portion of the fixation ring body 32A is relatively higher than the lightness of an outermost peripheral surface of the fixation ring body 32A. In addition, regarding the decorative ring 100, the effect is achieved as long as at least the lightness of the end surface 105 (the second portion) on the front side of the innermost peripheral portion is relatively higher than the lightness of an inner peripheral surface of the decorative ring 100. Therefore, for example, the same effect can be achieved by making the lightness of the outer peripheral surface of the fixation ring body 32A relatively lower than the lightness of the end surface 32E and making the lightness of the inner peripheral surface of the decorative ring 100 relatively lower than the lightness of the end surface 105. In order to make the lightness of the outer peripheral surface of the fixation ring body 32A lower than the lightness of the end surface 32E, for example, a method of painting the outer peripheral surface of the fixation ring body 32A with paint of which the lightness is lower than the lightness of the end surface 32E or a method of making the surface roughness of the outer peripheral surface of the fixation ring body 32A higher than the surface roughness of the end surface 32E (decreasing the reflectivity) can be adopted. Similarly, in order to make the lightness of the inner peripheral surface of the decorative ring 100 lower than the lightness of the end surface 105, for example, a method of painting the inner peripheral surface of the decorative ring 100 with paint of which the lightness is lower than the lightness of the end surface 105 or a method of making the surface roughness of the inner peripheral surface of the decorative ring 100 higher than the surface roughness of the end surface 105 (decreasing the reflectivity) can be adopted.

### Decorative Ring

Although the decorative ring 100 of the above-described embodiments has a configuration in which the annular projection portion 104 is provided at an inner peripheral portion of an end surface on the front side (the object side, the decorative ring 100 may be configured to be flat.

In addition, although the decorative ring 100 of the above-described embodiments has a configuration in which the projection portion 104 has a stepped shape of which the diameter decreases toward the front side in a stepwise manner, the projection portion 104 may have a tapered shape of which the diameter continuously decreases toward the front side.

The same applies to the first lens frame 30. That is, a front end portion of the fixation ring body 32A may have a tapered shape of which the diameter continuously decreases toward the rear side.

In addition, although the decorative ring 100 of the above-described embodiments is used as a nameplate, there may be no inscription thereon. Alternatively, other information (information other than the details and the specifications) may be inscribed thereon.

In addition, although a decorative ring having a shape that is completely closed as a circle is adopted as the decorative ring 100 of the above-described embodiments, the decorative ring 100 may have a partially open shape. The same applies to the frame shapes of the first frame, the second frame, and the third frame, and the shapes of the frames are not limited to a shape completely closed in the circumferential direction and include a shape of which the circumference is partially open.

### Optical Adjustment Function

In the above-described embodiments, a case where the present invention is applied to an interchangeable lens having a function for tilt adjustment as a function for optical adjustment has been described as an example. However, examples of the function for optical adjustment are not limited thereto. Alternatively, for example, the present invention can be similarly applied to an interchangeable lens having an axial distance adjustment function instead of a tilt adjustment function or in addition to the tilt adjustment function. Axial distance adjustment is performed, for example, by moving an adjustment target lens group forward and backward along an optical axis. In a case where the axial distance adjustment is to be performed by means of the first lens group L1, the first lens frame 30 is moved forward and backward along the optical axis. That is, the position of the first lens frame 30 is relatively changed along the optical axis Z with respect to the lens barrel body 20. Note that in the interchangeable lens 1 described in the above-described embodiments, axial distance adjustment also can be performed. That is, the three attachment portions 33 of the first lens frame 30 are moved by the same displacement amount. Accordingly, the first lens frame 30 is moved forward and backward along the optical axis while maintaining the posture thereof.

### Others

In the above-described embodiments, a case where the present invention is applied to an interchangeable lens having a zoom function has been described as an example. However, the application of the present invention is not limited thereto. The present invention can be similarly applied to a lens barrel of a so-called fixed focal lens.

In addition, in the above-described embodiments, a case where the present invention is applied to an interchangeable lens of a lens-interchangeable camera has been described as an example. However, the application of the present invention is not limited thereto. The present invention can be similarly applied to a lens barrel of a lens provided in a lens-integrated camera. In addition, the present invention can be applied to a lens barrel of an optical device other than a camera. Note that examples of the camera include various cameras such as a video camera, a TV camera, and a cine-camera in addition to a so-called still camera.

### EXPLANATION OF REFERENCES

1: interchangeable lens
10: lens barrel
11: mount
12: focus ring
13: zoom ring
20: lens barrel body
21: guide shaft
22: zoom motor
23: lead screw
24: nut
25: main shaft
26: sub shaft
30: first lens frame
31: first lens frame body
31A: female screw portion
32: fixation ring
32A: fixation ring body
32B: flange portion
32C: male screw portion
32D: inclined surface
32E: end surface
33: attachment portion
33A: screw attachment hole
33B: spring engagement portion
40: second lens frame
50: third lens frame
60: fourth lens frame
70: fifth lens frame
80: exterior body
81: front cover
81A: light shielding groove
81B: decorative ring mounting portion
81C: recess portion
82: rear cover
91: adjustment screw
92: support portion
92A: screw hole
92B: spring holding portion
93: spring
100: decorative ring
101: mounting surface
102: flat surface
103: inclined surface
104: projection portion
105: end surface
106: recess portion
107: bottom surface
108: end surface
L1: first lens group
L2: second lens group
L3: third lens group
LA: fourth lens group
L5: fifth lens group
S: stop
SU: stop unit
W: rectangular region
Z: optical axis

What is claimed is:

1. A lens barrel comprising:
a first frame;
a second frame that holds a lens positioned closest to an object side, that is accommodated in the first frame, and of which a position and/or a degree of inclination is adjustable with respect to the first frame; and
a third frame that is attached to the first frame and that is disposed between an inner periphery of the first frame and an outer periphery of the second frame as seen from the object side,
wherein a first portion of the second frame that is positioned closest to the object side in an optical axis direction is disposed between a second portion of the third frame that is positioned closest to the object side and a third portion of the third frame that is positioned closest to an image side.

2. The lens barrel according to claim 1,
wherein the first portion is positioned at a position closer to the image side than the second portion is by a distance equal to or greater than a distance δ.

3. The lens barrel according to claim 2,
wherein a value that exceeds a maximum amount of displacement of the first portion in the optical axis direction that is caused due to the adjustment is set as the distance δ.

4. The lens barrel according to claim 1,
wherein the first portion is positioned at a position closer to the image side than the second portion is by a distance equal to or greater than a distance ξ in a case where the position and/or the degree of inclination of the second frame is adjusted by a maximum adjustment amount.

5. The lens barrel according to claim 4,
wherein the distance ξ is 0.3 mm.

6. The lens barrel according to claim 1,
wherein the third frame includes an annular recess portion provided at an inner peripheral portion as seen from the object side, and
the first portion is positioned closer to the object side than a fourth portion of the recess portion that is positioned closest to the image side.

7. The lens barrel according to claim 1,
wherein the third frame includes an annular projection portion provided at an inner peripheral portion of an end surface on the object side.

8. The lens barrel according to claim 7,
wherein the projection portion of the third frame has a tapered shape of which a diameter decreases toward the object side.

9. The lens barrel according to claim 8,
wherein an end portion of the second frame that is on the object side has a tapered shape of which a diameter decreases toward the image side.

10. The lens barrel according to claim 7,
wherein the projection portion of the third frame has a stepped shape of which a diameter decreases toward the object side in a stepwise manner.

11. The lens barrel according to claim 10,
wherein an end portion of the second frame that is on the object side has a stepped shape of which a diameter decreases toward the image side in a stepwise manner.

12. The lens barrel according to claim 1,
wherein the second frame includes the first portion provided at a portion adjacent to an inner periphery of the third frame as seen from the object side.

13. The lens barrel according to claim 1,
wherein the first portion and the second portion are disposed to be adjacent to each other as seen from the object side.

14. The lens barrel according to claim 1,
wherein the first portion and the second portion have the same hue.

15. The lens barrel according to claim 14,
wherein Munsell chroma values of the first portion and the second portion are equal to or smaller than a threshold value.

16. The lens barrel according to claim 14,
wherein a hue difference related to a hue ring in Munsell color system between the first portion and the second portion is equal to or smaller than a threshold value.

17. The lens barrel according to claim 14,
wherein lightness of the first portion and the second portion of the second frame and the third frame is relatively high.

18. The lens barrel according to claim 14,
wherein lightness of the first portion and the second portion is relatively higher than lightness of an outer peripheral surface of the second frame and lightness of an inner peripheral surface of the third frame.

19. The lens barrel according to claim 1,
wherein the third frame is a nameplate.
